(19) United States
(12) Patent Application Publication
(10) Pub. No.: US 2016/0004538 A1
(43) Pub. Date: Jan. 7, 2016

(54) MULTIPLE ISSUE INSTRUCTION PROCESSING SYSTEM AND METHOD

(71) Applicant: SHANGHAI XINHAO MICROELECTRONICS CO. LTD., Shanghai (CN)

(72) Inventor: KENNETH CHENGHAO LIN, Shanghai (CN)

(21) Appl. No.: 14/766,756

(22) PCT Filed: Jan. 29, 2014
(86) PCT No.: PCT/CN2014/071799

§ 371 Date: Aug. 9, 2015

(30) Foreign Application Priority Data
Feb. 8, 2013 (CN) 201310050848.0

(51) Int. Cl. G06F 9/38; G06F 9/30

(52) U.S. Cl. CPC G06F 9/3851; G06F 9/30058

(57) ABSTRACT

A multiple issue instruction processing system is provided. The system includes a central processing unit (CPU), a memory system and an instruction control unit. The CPU is configured to execute one or more instructions of the executable instructions at the same time. The memory system is configured to store the instructions. The instruction control unit is configured to, based on location of a branch instruction stored in a track table, control the memory system to output the instructions likely to be executed to the CPU.

### TECHNICAL FIELD

The present invention generally relates to computer architecture and, more particularly, to the methods and systems for multiple issue instruction processing.

### BACKGROUND ART

In today's computer architecture, the performance of a processor is improved mainly by increasing processor frequency. However, with the increase in the number of transistors integrated in a chip, power consumption and heat dissipation problems become more severe. The method of only increasing the processor frequency is difficult to be adapted to the development of the processor. In such cases, a simple and effective processor pipeline control method may be needed to improve the efficiency in instruction execution. In other words, instruction pipeline control can be implemented by fewer hardware resources, thereby achieving higher instruction throughput.

In pipelining techniques, execution of each instruction is split into a sequence of dependent stages. Each pipeline stage can complete partial function of the instruction. When multiple instructions are executed simultaneously, different stages of multiple instructions may be executed simultaneously. In practice, data dependency relationships possibly exist among different instructions. For example, a source operand of one instruction is a target operand of the previous instruction, which is a read after write (RAW) hazard. Pipelining technique does not reduce the time to complete an instruction, but increases instruction throughput (the number of instructions that can be executed in a unit of time) by performing multiple operations in parallel.

### DISCLOSURE OF INVENTION

### Technical Problem

In existing technologies, the above described functionalities can be implemented through a processor with multiple issue characteristics. The processor can perform a plurality of instructions at the same time. However, due to the dependency characteristic of the pipelining technology, the pipelining technology often cannot take full advantage of the above described performance of the processor. For example, a processor may execute four instructions at the same time. But due to the dependency characteristic of the pipelining technology, only three instructions are provided for the processor to execute at the same time. Therefore, the multiple issue characteristics of the processor cannot be taken full advantage, reducing the performance of the processor to execute the instructions.

### SOLUTION TO PROBLEM

### Technical Solution

The disclosed system and method and are directed to solve one or more problems set forth above and other problems.

One aspect of the present disclosure includes a multiple issue instruction processing system. The system includes a central processing unit (CPU), a memory system and an instruction control unit. The CPU is configured to execute one or more instructions of the executable instructions at the same time. The memory system is configured to store the instructions. The instruction control unit is configured to, based on location of a branch instruction stored in a track table, control the memory system to output the instructions likely to be executed to the CPU.

Another aspect of the present disclosure includes a multiple issue instruction processing method. The method includes a memory system storing instructions. The method also includes an instruction control unit controlling the memory system to output the instructions likely to be executed to a CPU based on location of a branch instruction stored in a track table. Further, the method includes the CPU receiving the instructions likely to be executed outputted by the memory system and executing one or more instructions of executable instructions at the same time.

Other aspects of the present disclosure can be understood by those skilled in the art in light of the description, the claims, and the drawings of the present disclosure.

### ADVANTAGEOUS EFFECTS OF INVENTION

### Advantageous Effects

In the multiple issue instruction processing system provided in the present disclosure, an instruction control unit configured to, based on location of a branch instruction stored in a track table, control the memory system to provide the instructions to be executed likely for the CPU to take full advantage of capability of CPU core to execute the instructions, improving performance of the multiple issue instruction processing system to execute the instructions. Other advantages and applications are obvious to those skilled in the art.

### BRIEF DESCRIPTION OF DRAWINGS

### Description of Drawings

FIG. 1 illustrates a structural schematic diagram of an exemplary multiple issue instruction processing system consistent with the disclosed embodiments;

FIG. 2 illustrates a schematic diagram of an exemplary instruction control unit of providing instructions consistent with the disclosed embodiments;

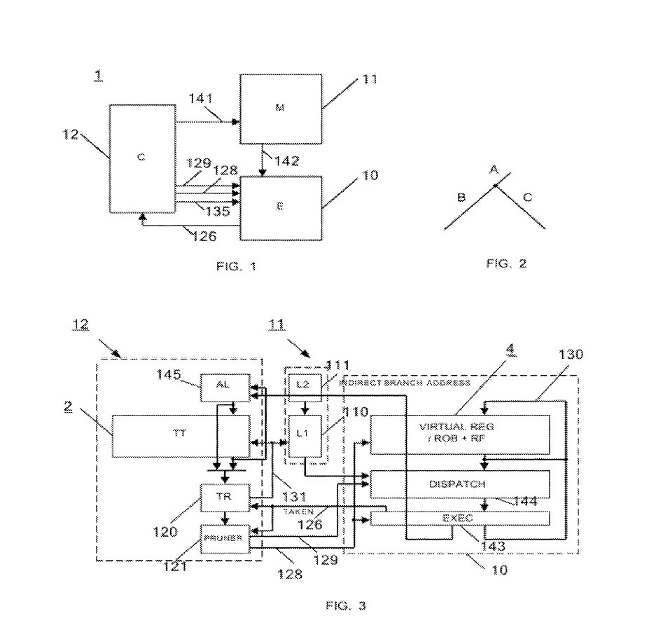

FIG. 3 illustrates another structural schematic diagram of an exemplary multiple issue instruction processing system consistent with the disclosed embodiments;

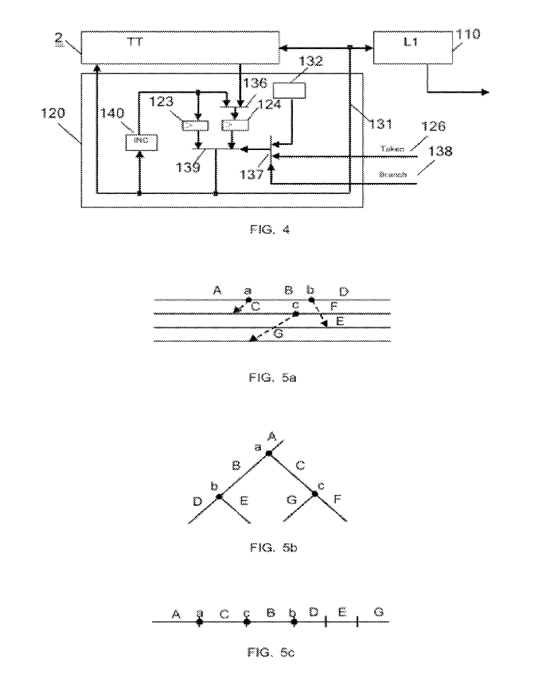

FIG. 4 illustrates a structural schematic diagram of an exemplary tracker consistent with the disclosed embodiments;

FIGS. 5a˜5c illustrate a schematic diagram of a corresponding relationship between a branch instruction and a branch instruction segment consistent with the disclosed embodiments;

FIG. 6a illustrates a schematic diagram of location format of an exemplary branch instruction stored in a memory unit of a track table consistent with the disclosed embodiments;

FIG. 6b illustrates a schematic diagram of an exemplary instruction selection consistent with the disclosed embodiments;

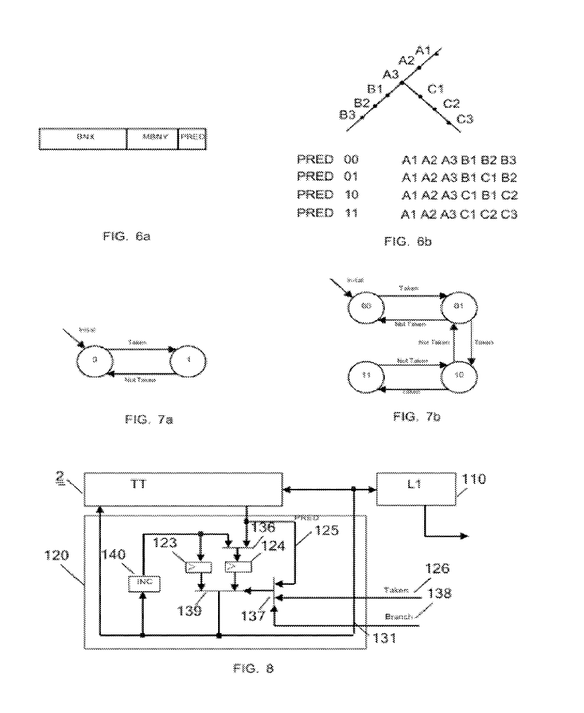

FIG. 7a˜7b illustrate a schematic diagram of an exemplary prediction bit consistent with the disclosed embodiments;

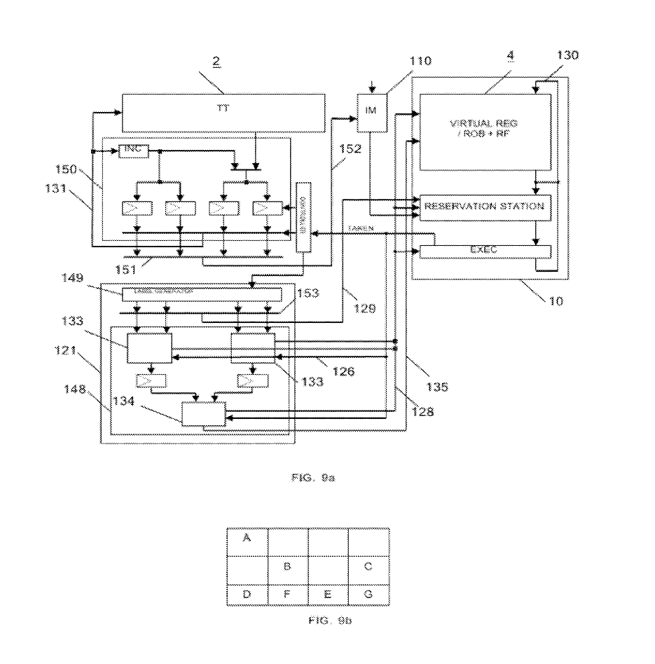

FIG. 8 illustrates another structural schematic diagram of an exemplary tracker consistent with the disclosed embodiments;

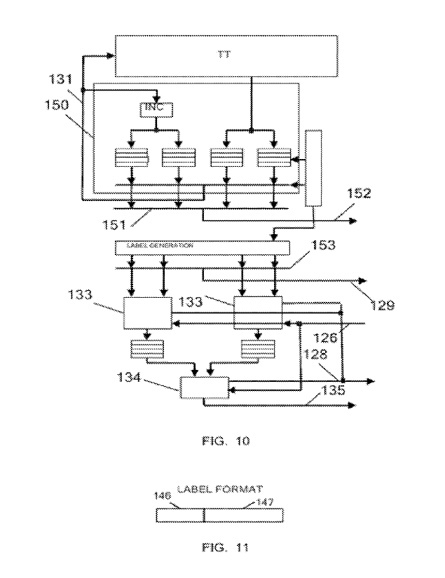

FIG. 9a illustrates another structural schematic diagram of an exemplary multiple issue instruction processing system consistent with the disclosed embodiments;

FIG. 9b illustrates a schematic diagram of an exemplary generating process of four registers of an tracker consistent with the disclosed embodiments;

FIG. 10 illustrates another structural schematic diagram of an exemplary multiple issue instruction processing system consistent with the disclosed embodiments; and

FIG. 11 illustrates a structural schematic diagram of an exemplary label generated by a segment pruner consistent with the disclosed embodiments.

### BEST MODE FOR CARRYING OUT THE INVENTION

### Best Mode

FIG. 3 illustrates an exemplary preferred embodiment(s).

### MODE FOR THE INVENTION

### Mode for Invention

Reference will now be made in detail to exemplary embodiments of the invention, which are illustrated in the accompanying drawings. The same reference numbers may be used throughout the drawings to refer to the same or like parts.

FIG. 1 illustrates a structure schematic diagram of an exemplary multiple issue instruction processing system consistent with the disclosed embodiments. As shown in FIG. 1, the multiple issue instruction processing system may include a central processing unit (CPU) core 10, a memory system 11, and an instruction control unit 12. It is understood that the various components are listed for illustrative purposes, other components may be included and certain components may be combined or omitted. Further, the various components may be distributed over multiple systems, may be physical or virtual components, and may be implemented in hardware (e.g., integrated circuit), software, or a combination of hardware and software.

The CPU core 10 is configured to execute a plurality of instructions at the same time.

The memory system 11 is configured to store the instructions. The instruction control unit 12 is configured to, based on the location of the branch instruction stored in a track table, control memory system 11 to provide the instructions to be likely executed for CPU core 10.

It should be noted that the term “an instruction (segment) most likely to be executed”, “an instruction (segment) certainly to be executed”, “an instruction (segment) certainly not to be executed” corresponds to three situations of an instruction (segment). Correspondingly, the first scenario: an instruction (segment) may be executed or may not be executed, that is, the probability of the instruction (segment) to be executed is greater than 0 and less than 1. The second scenario: an instruction (segment) must be executed, that is, the probability of the instruction (segment) to be executed is 1. The third scenario: an instruction (segment) must not be executed, that is, the probability of the instruction (segment) to be executed is 0.

The track table contains a plurality of track points. A track point is a single entry in the track table containing information of at least one instruction, such as instruction type information, branch target address, etc. As used herein, a track address of the track point is a track table address of the track point itself, and the track address is constituted by a row number and a column number. The track address of the track point corresponds to the instruction address of the instruction represented by the track point. The track point (i.e., branch point) of the branch instruction contains the track address of the branch target instruction of the branch instruction in the track table, and the track address corresponds to the instruction address of the branch target instruction.

For illustrative purposes, BN represents a track address. BNX represents a row number of the track address, and BNY represents a column number of the track address. Thus, track table may be configured as a two dimensional table with X number of rows and Y number of columns, in which each row, addressable by BNX, corresponds to one memory block or memory line, and each column, addressable by BNY, corresponds to the offset of the corresponding instruction within memory blocks. Accordingly, each BN containing BNX and BNY also corresponds to a track point in the track table. That is, a corresponding track point can be found in the track table according to one BN.

Instruction control unit 12 controls memory system 11 through bus 141 to provide instruction 142 for CPU core 10. The different instructions (segments) are given different segment number 129. Each instruction (segment) has only one branch instruction. Specifically, each branch instruction and instructions between the branch instruction and the previous branch instruction is defined as an instruction (segment). CPU core 10 feeds back an instruction execution result 126 to instruction control unit 12. Specially, CPU core 10 feeds back a branch instruction execution result 126 to instruction control unit 12. That is, the branch instruction execution result 126 indicates whether the branch instruction takes a branch.

According to the received branch instruction execution result 126, instruction control unit 12 distinguishes instructions most likely to be executed, instructions certainly to be executed, and instructions certainly not to be executed. The segment number 128 corresponding to the instructions that are certainly not to be executed can be sent to CPU core 10, such that execution results or intermediate results of the instructions that are certainly not to be executed can be cleared. The segment number 135 corresponding to the instructions that are certainly to be executed can be sent to CPU core 10, such that execution results of the instructions that are certainly to be executed can be written to physical registers.

Before CPU core 10 generates an execution result of a branch instruction, instruction control unit 12 may provide instructions in a fall-through instruction (segment) and a target instruction (segment) of the branch instruction for CPU core 10 to execute. That is, based on the branch instruction address stored in the track table, instruction control unit 12 controls the memory system 11 to provide the instructions that are most likely to be executed for the CPU. Thus, CPU core 10 can obtain enough instructions to execute, taking full advantage of the CPU core's ability to execute instructions and improving the performance of multiple issue instruction processing system 1 to execute the instructions.

FIG. 2 illustrates a schematic diagram of an exemplary instruction control unit of providing instructions consistent with the disclosed embodiments. As show in FIG. 2, instructions contained in an instruction (segment) A are instructions that are certainly to be executed. The last instruction in the instruction (segment) A is a branch instruction. The fall-through instruction (segment) of the branch instruction is an instruction (segment) B. The target instruction (segment) of the branch instruction is an instruction (segment) C. Before an execution result of the branch instruction is generated, the instruction (segment) B and the instruction (segment) C are the instruction (segment) that is most likely to be executed.

Even using the current branch prediction technologies, one of the instruction (segment) B and the instruction (segment) C can be selected and sent for CPU core 10 to execute, the capability of CPU core 10 to execute the instructions cannot be taken full advantage because of correlation among different instructions in the selected instruction (segment). As used herein, instruction control unit 12 provides instructions of the instruction (segment) B and the instruction (segment) C for CPU core 10 to execute. The capability of CPU core 10 to execute the instructions can be taken full advantage because of no correlation among instructions in different instructions (segments).

In one embodiment, before an existing CPU with a deeper pipeline structure generates an execution result of a branch instruction, the instructions of the fall-through instruction segments and the target instruction segments corresponding to more levels of branch instructions are sent to CPU to execute. At this time, once the execution result of a certain branch instruction is generated, one of a fall-through instruction segment and a target instruction segment of the branch instruction becomes an instruction segment certainly to be executed. Various instruction segments after the branch instruction of the instruction segment are instruction segments likely to be executed. The other one of the fall-through instruction segment and the target instruction segment of the branch instruction are instruction segments certainly not to be executed. Various instruction segments after the other instruction segment are also instruction segments certainly to not be executed.

After the branch instruction execution result is generated, one of instruction segment B or instruction segment C becomes the instruction segment certainly to be executed. The other one of instruction segment B or instruction segment C becomes the instruction segment certainly not to be executed. Based on the branch instruction execution result sent by CPU core 10, instruction control unit 12 may distinguish which segment becomes the instruction segment certainly to be executed and which segment becomes the instruction segment certainly not to be executed. Instruction control unit 12 sends a corresponding segment number 129 to CPU core 10. Instruction control unit 12 deletes the execution results and intermediate results corresponding to the instruction segment certainly not to be executed, and writes the execution result corresponding to the instruction segment certainly to be executed to the physical register at the same time.

FIG. 3 illustrates another structure schematic diagram of an exemplary multiple issue instruction processing system consistent with the disclosed embodiments. As shown in FIG. 3, the CPU core is configured to execute a plurality of instructions of executable instructions at the same time. The execution results outputted by execution unit 143 are sent to register file 4 (e.g., a virtual register or a reorder buffer) via bus 130 to write back to the physical register in the future. The execution results outputted by execution unit 143 are bypass to dispatch unit 144 via bus 130 for the subsequent instructions to use. Instruction control unit 12 also includes an active table 145. The active table 145 contains a corresponding relationship between location information of the branch instructions stored in the track table and instruction addresses of the branch instructions.

When memory system 11 contains only one level of memory, rows of the track table correspond to rows in the memory one by one. When memory system 11 contains more than one level of memory devices, rows of the track table correspond to rows of memory that is the closest to the CPU core 10 in memory system 11 one by one. “Memory that is the closest to the CPU core” refers to the memory that is closest to the CPU core in memory hierarchy, and it is usually the fastest memory, such as L1 cache level, or a first level memory.

Further, the instruction control unit 12 also includes a tracker 120. Based on the location of the branch instruction stored in the track table 2, read pointer 131 of the tracker 120 moves in advance from the first branch instruction after the instruction being executed by CPU core 10 and points to a branch instruction after a number of levels of branches. Based on the branch instruction passed in the process of read pointer 131 moving, the instruction control unit 12 selects the instruction in the corresponding instruction segment, and controls the memory system 11 (the memory system 11 includes a level one (L1) memory 110 and a level two (L2) memory 111) to provide the selected instruction for the CPU core 10.

Tracker 120 may point to different rows in the track table. Based on the row of the track table pointed to by the read pointer 131 of the tracker 120, instruction control unit 12 may find a corresponding instruction segment in memory system 11. Or based on a target instruction address in the entry of the track table pointed to by the read pointer 131 of the tracker 120, instruction control unit 12 may find a corresponding instruction segment in memory system 11.

FIG. 9a illustrates another structure schematic diagram of an exemplary multiple issue instruction processing system consistent with the disclosed embodiments. As shown in FIG. 9a, instruction control unit 12 may also include a segment pruner 121. The label generator 149 of the segment pruner 121 gives different segment numbers to different segments, and sends the segment numbers via bus 129 to CPU core 10. Based on the execution result of the branch instruction, the segment pruner 121 also distinguishes segment number of the instruction segment certainly not to be executed. The segment number of the instruction segment certainly not to be executed is sent to CPU core 10 via bus 128, such that the execution results or intermediate results of these instructions can be cleared.

FIG. 4 illustrates a structure schematic diagram of an exemplary tracker consistent with the disclosed embodiments. As shown in FIG. 4, the tracker includes two registers, which store branch instructions of a fall-through instruction segment and a target instruction segment, respectively.

In one embodiment, read pointer 131 of the tracker 120 moves in advance and points to a branch instruction after one level branch. That is, the tracker 120 moves to a second level instruction segment in advance in FIG. 4. Read pointer 131 of the tracker 120 may also move in advance and point to a branch instruction after a number of levels of branches.

As used herein, when an instruction pointed to by read pointer 131 of the tracker 120 is a branch instruction (that is, the value of read pointer 131 is a branch source instruction address), instruction type read out from track table 2 is decoded to obtain a branch instruction type. At this time, selector 136 selects the value of a target instruction segment address outputted by the track table 2 and stores the selected address value to register 124. At the same time, selector 136 adds 1 to the value of the branch source instruction address of read pointer 131 by incrementer 140 to obtain the value of the fall-through instruction segment address and stores the obtained address value into the register 123.

Before the execution result of the branch instruction is generated, instructions of the fall-through instruction segment and the target instruction segment of the branch instruction are provided for CPU core 10. The instructions of the fall-through instruction segment and the target instruction segment of the branch instruction are evenly selected herein. Signal 138 indicates whether the branch instruction is executed completely. When the branch instructions is not executed completely, signal 138 controls selector 137 to select the output from selection logic 132 to control selector 139.

Selection logic 132 alternately controls selector 139 to select the address value stored in register 123 and register 124. Specifically, when selection logic 132 controls selector 139 to select the address value stored in register 123, the value outputted by read pointer 131 to L1 memory 110 is the address value stored in register 123. Based on the address, L1 memory 110 outputs the corresponding instructions to CPU core 10 and labels these instructions as “the branch is not taken” for CPU core 10 to execute. At the same time, the address value is added 1 by incrementer 140 to obtain a next address of the instruction segment and store the obtained next address into the register 123 (while updating register 123, the value of register 124 remains unchanged).

When selection logic 132 controls selector 139 to select the address value stored in register 124, the value outputted by read pointer 131 to L1 memory 110 is the address value stored in register 124. Based on the address, L1 memory 110 outputs the corresponding instructions to CPU core 10 and labels these instructions as “the branch is taken” for CPU core 10 to execute. At the same time, the address value is added 1 by incrementer 140 to obtain a next address. If the instruction pointed to by read pointer 131 is not a branch instruction at this time, selector 136 selects the next address outputted by incrementer 140 and stores the obtained next address value into register 124 (while updating register 124, the value of register 123 remains unchanged). Such pattern is repeatedly executed. The instructions of the fall-through instruction segment and the target instruction segment of the branch instruction are continuously and evenly selected from L1 memory 110 for CPU core 10 to execute until read pointer 131 points to a branch instruction.

Specifically, when read pointer 131 points to any one branch instruction of the fall-through instruction segment and target instruction segment, read pointer 131 stops to move. Other methods can also be used herein. For example, when read pointer 131 points to the branch instruction of the fall-through instruction segment, the updating of register 123 is stopped. But the updating of register 124 is still allowed until read pointer 131 points to a branch instruction of the target instruction segment. Thus, more instructions may be provided for CPU core 10 to execute, taking full advantage of capability of CPU core to execute the instructions. Other similar methods can also be used, which are not repeated herein.

When the branch instruction is executed completely, signal 138 controls selector 137 to select determination information 126 from CPU core 10 which indicates whether or not a branch is taken to control selector 139. Specifically, if the branch is not taken, the address value currently stored in register 123 is selected as a new value of read pointer 131. If the branch is taken, the address value currently stored in register 124 is selected as a new value of read pointer 131. Thus, read pointer 131 can continuously move along a correct track. A next branch instruction is performed a similarly speculative execution. At the same time, instruction control unit 12 sends information to the CPU core 10. Based on information on whether or not the branch is taken, instruction control unit 12 keeps execution result of a speculative execution instruction with a same label in CPU core 10, and clears the execution result or intermediate result of a speculative execution instruction with a different label.

FIGS. 5A˜5C illustrate a schematic diagram of a corresponding relationship between a branch instruction and an instruction segment consistent with the disclosed embodiments. As shown in FIGS. 5A˜5C, “A”, “B”, “C”, “D”, “E”, “F”, and “G” indicate an instruction segment, respectively. Also, rough point ‘a’, ‘b’ and ‘c’ in FIGS. 5a˜5b indicate a branch instruction, respectively. FIG. 5a shows a specific location of a branch instruction and an instruction segment in the memory. FIG. 5b shows a relationship between the branch instruction and the instruction segment of FIG. 5a.

Three levels of instruction segments are shown in FIG. 5a. Three levels of instruction segments are a L1 instruction segment “A”, a L2 instruction segment “B”, a L2 instruction segment “C”, a L3 instruction segment “D”, a L3 instruction segment “E”, a L3 instruction segment “F”, and a L3 instruction segment “G”, respectively. Where L2 instruction segment “B” is a fall-through instruction segment of L1 instruction segment “A”; L2 instruction segment “C” is a target instruction segment of L1 instruction segment “A” (that is, when the branch instruction of L1 instruction segment “A” takes a branch, read pointer 131 jumps to L2 instruction segment “C”) ; L3 instruction segment “D” is a fall-through instruction segment of L2 instruction segment “B”; L3 instruction segment “E” is a target instruction segment of L2 instruction segment “B”; L3 instruction segment “F” is a fall-through instruction segment of L2 instruction segment “C”; and L3 instruction segment “G” is a target instruction segment of L2 instruction segment “C”.

Based on the location of the branch instruction stored in track table 2, read pointer 131 of the tracker 120 moves in advance from a first branch instruction of an instruction being executed by CPU core 10 and points to a branch instruction after a number of levels of branches. For example, read pointer 131 of the tracker 120 moves to a point of intersection between L2 instruction segment “B” and L3 instruction segment “D, E” (i.e. branch instruction b), a point of intersection between L2 instruction segment “C” and L3 instruction segment “F, G” (i.e. branch instruction c), or a lower level branch instruction.

When read pointer 131 of the tracker 120 moves, instruction control unit 12 may select an instruction of the corresponding instruction segment. For example, instruction control unit 12 may select an instruction of instruction segment “B” and instruction segment “C”, and control memory system 11 to output the selected instruction to CPU core 10.

Instruction control unit 12 may select an instruction through the following methods.

1. The instructions of the fall-through instruction segment and the target instruction segment of every level branch are evenly selected herein. For example, a fall-through instruction segment “B” and a target instruction segment “C” of a L1 branch are evenly selected. It is assumed that both instruction segment “B” and instruction segment “C” contain 5 instructions, respectively. When average selection principle is used, two instructions of instruction segment “B” and two instructions of instruction segment “C” may be selected in order. Or instructions of instruction segment “C” are first selected, and then instructions of instruction segment “B” are selected. As shown in FIG. 5C, instruction segment “A” contains instructions to be executed certainly; then, all instructions in instruction segment “C” are selected; then, all instructions in the instruction segment “B”, “D”, “E”, and “G” are selected in order. All selected instructions in order from left to right are sent to a CPU core to execute until the CPU core generates an execution result of the branch instruction a in instruction segment “A”.

2. Based on a certain algorithm, the instructions of the fall-through instruction segment and the target instruction segment of every level branch are unevenly selected. It should be noted that “certain algorithm” may be any algorithm that can implement the above functions. There are no limitations for the algorithm herein. For example, based on “certain algorithm”, when instructions are selected, the instructions selected from the target instruction segment of every level branch are one more than the instructions selected from the fall-through instruction segment.

3. A branch prediction bit (that is, prediction whether a branch instruction takes a branch) of the branch instruction is stored in the track table 2, wherein the branch prediction bit provides prediction probability that the branch is taken. FIG. 6a illustrates a schematic diagram of location format of an exemplary branch instruction stored in a memory unit of a track table consistent with the disclosed embodiments. As shown in FIG. 6a, “PRED” is a branch prediction bit, representing prediction probability that the branch instruction is taken. “BNX” and “BNY” may refer to FIG. 2. The described prediction bit is a single bit or a plurality of bits, and the initial value of the prediction bit is set to a fixed value or a value that changes based on a branch jump direction of the branch instruction.

FIG. 7a illustrates a schematic diagram of an exemplary prediction bit consistent with a single bit consistent with the disclosed embodiments. FIG. 7b illustrates a schematic diagram of an exemplary prediction bit with 2 bits (one of a plurality of bits) consistent with the disclosed embodiments. In addition, the prediction bit can also be three bits, four bits, or even more bits. The initial value of the prediction bit can be set to a fixed value or a value that changes based on a branch jump direction of the branch instruction.

There are three initial value set methods for the prediction bit with a single bit. The initial value is set to ‘0’ to indicate that the branch is not taken; the initial value is set to ‘1’ to indicate that the branch is taken; or the initial value is set according to the branch jump direction of a branch instruction. For example, the initial value of the prediction bit of the forward branch instruction is set to ‘0’ to indicate that the branch is not taken, and the initial value of the prediction bit of the backward branch instruction is set to ‘1’ to indicate that the branch is taken. Of course, in other embodiments, the initial value of the prediction bit of the branch instruction can also be set to the opposite value.

When the prediction bit corresponding to the branch instruction is also stored in track table 2, based on the prediction bit, instruction control unit 12 select the instruction.

When the probability that the branch instruction takes a branch is higher than the probability that the branch is not taken, the instruction control unit controls the memory system to provide the instructions of the target instruction segment and the fall-through instruction segment of the branch instruction for the CPU. In the provided instructions, the instructions of the target instruction segment are more than the fall-through instruction segment of the branch instruction.

When the probability that the branch instruction takes a branch is lower than the probability that the branch is not taken, the instruction control unit controls the memory system to provide the instructions of the target instruction segment and the fall-through instruction segment of the branch instruction for the CPU. In the provided instructions, the instructions of the target instruction segment are less than the fall-through instruction segment of the branch instruction.

For example, when the initial value of the prediction bit of certain branch instruction is set to ‘0’ to indicate that the branch is not taken. That is, the probability that the branch instruction takes a branch is lower than the probability that the branch is not taken. At this point, a total number of the selected instructions of the instruction segment “B” may be more than a total number of the selected instructions of the instruction segment “C”.

FIG. 6b illustrates a schematic diagram of an exemplary instruction selection consistent with the disclosed embodiments. As shown in FIG. 6b, there are 3 instruction segments. Instruction segment A contains instruction A1, A2, and A3, where A3 is a branch instruction. The fall-through instruction segment B of the branch instruction A3 contains instruction B1, B2, and B3. The target instruction segment C of the branch instruction A3 contains instruction C1, C2, and C3. Instruction segment A is an instruction segment certainly to be executed. Instruction segment B and C are an instruction segment likely to be executed. It is assumed that all the instructions in instruction segment B and C have no correlation.

When the value of prediction bit (PRED) corresponding to an instruction A3 is ‘00’ (it indicates that the branch is most likely not to be taken), the instructions A1, A2, A3, B1, B2, and B3 are selected by instruction control unit 12 in order and are sent to a CPU core to execute. That is, all the instructions in instruction segment B are selected.

When the value of prediction bit (PRED) corresponding to an instruction A3 is ‘01’ (it indicates that the branch is likely not to be taken), the instructions A1, A2, A3, B1, C1, and B2 are selected by instruction control unit 12 in order and are sent to a CPU core to execute. That is, a total number of the instructions selected from the instruction segment “B” is more than a total number of the instructions selected from the instruction segment “C”.

When the value of prediction bit (PRED) corresponding to an instruction A3 is ‘10’ (it indicates that the branch is likely to be taken), the instructions A1, A2, A3, C1, B1, and C2 are selected by instruction control unit 12 in order and are sent to a CPU core to execute. That is, a total number of the instructions selected from the instruction segment “C” is more than a total number of the instructions selected from the instruction segment “B”.

When the value of prediction bit (PRED) corresponding to an instruction A3 is ‘11’ (it indicates that the branch is most likely to be taken), the instructions A1, A2, A3, C1, C2, and C3 are selected by instruction control unit 12 in order and are sent to a CPU core to execute. That is, all the instructions in instruction segment C are selected. Of course, in actual implementation, because of the correlation between the instructions and other reasons, the selection order of the instructions is slightly different, which can be carried out under the similar method in the embodiment. The detailed description is not repeated herein.

Further, based on information on whether the branch instruction executed by CPU core 10 takes a branch, the prediction value corresponding to the branch instruction in track table 2 may be modified.

As shown in FIG. 7a, the initial value of the prediction bit of certain branch instruction is set to ‘0’ to indicate that the branch is not taken. When the branch instruction is executed, if the branch is not taken, the prediction bit is kept to ‘0’. When the branch instruction is executed, if the branch is taken, the prediction bit is updated to ‘1’. Then, when the branch instruction is executed, if the branch is taken, the prediction bit is kept to ‘1’; when the branch instruction is executed, if the branch is not taken, the prediction bit is updated to ‘0’.

As shown in FIG. 7b, the prediction bit of certain branch instruction is two bits. The initial value of the prediction bit of the branch instruction is set to ‘00’. Based on information on whether the branch instruction executed by CPU core 10 takes a branch, the prediction value corresponding to the branch instruction may be modified. The prediction bit ‘00’ indicates that the branch is most likely not to be taken. The prediction bit ‘01’ indicates that the branch is likely not to be taken. The prediction bit ‘10’ indicates that the branch is likely to be taken. The prediction bit ‘11’ indicates that the branch is most likely to be taken. Thus, when the branch instruction does not take a branch, the corresponding prediction bit is modified to the status that the branch is more likely not to be taken. When the branch instruction takes a branch, the corresponding prediction bit is modified to the status that the branch is more likely to be taken.

Based on the value of the prediction bit, tracker 120 may select instructions of the fall-through instruction segment and the target instruction segment of the branch instruction in different proportions. FIG. 8 illustrates another structure schematic diagram of an exemplary tracker consistent with the disclosed embodiments. When read pointer 131 of tracker 120 moves in advance and points to a branch instruction after one level of branch, based on the value of the prediction bit, tracker 120 may select instructions. When read pointer 131 of tracker 120 moves in advance and points to a branch instruction after a number of levels of branches, based on the value of the prediction bit, tracker 120 may also select instructions by the similar method shown in FIG. 8.

When read pointer 131 of tracker 120 points to a branch instruction (that is, the value of read pointer 131 is an address of a branch source instruction), instruction type read out from track table 2 is a branch instruction type by decoding. At this time, selector 136 selects the value of a target instruction segment address outputted by the track table 2 and stores the selected address value to register 124. At the same time, selector 136 adds 1 to the value of the branch source instruction address of read pointer 131 by incrementer 140 to obtain the value of the fall-through instruction segment address and stores the obtained address value into the register 123.

Prediction information 125 indicating whether the branch of the branch instruction is taken may be read out from track table 2. Based on prediction information 125, selector 136 selects one from the value of the fall-through instruction segment address stored in register 123 and the value of the target instruction segment address stored in register 124 as a new value of read pointer 131 of tracker 120. Thus, read pointer 131 continues to move ahead to control L1 memory 110 to output the instructions. The outputted instructions are labeled and provided for CPU core 10 to execute until read pointer 131 points to a branch instruction.

If prediction information 125 indicates the branch instruction most likely does not take a branch (similar to the embodiment in FIG. 4), when the branch instruction is not executed completely, signal 138 controls selector 137 to select prediction information 125 to control selector 139 to select the address value stored in register 123 as the value of read pointer 131. Thus, read pointer 131 outputs the address value currently stored in register 123 to L1 memory 110. Based on the address, L1 memory 110 provides the corresponding instructions and labels the instructions as “the branch is not taken” (i.e. instructions in the next instruction segment) for CPU core 10 to execute. At the same time, the address value is added 1 by incrementer 140 to obtain the next address of the instruction segment, and the next address is stored in register 123 (when updating register 123, the value stored in register 124 is kept unchanged), and so forth. Thus, read pointer 131 moves ahead to control L1 memory 110 to provide the instructions for CPU core 10 to execute until the read pointer 131 points to a branch instruction.

If prediction information 125 indicates the branch instruction most likely takes a branch, when the branch instruction is not executed completely (similar to the embodiment in FIG. 4), signal 138 controls selector 137 to select prediction information 125 to control selector 139 to select the address value stored in register 124 as the value of read pointer 131. Thus, read pointer 131 outputs the address value currently stored in register 124 to L1 memory 110. Based on the address, L1 memory 110 provides the corresponding instructions (i.e. instructions in the target instruction segment) and labels the corresponding instructions as “the branch is taken” for CPU core 10 to execute. At the same time, the address value is added 1 by incrementer 140 to obtain the next address of the instruction segment, and the next address is stored in register 124 (at this time, selector 136 selects the output of incrementer 140 to update register 124, and the value stored in register 123 is unchanged), and so on. Thus, read pointer 131 moves ahead to control L1 memory 110 to provide the instructions for CPU core 10 until the read pointer 131 points to a branch instruction.

When the branch instruction is executed completely, signal 138 controls selector 137 to select determination information 126 indicating whether a branch is taken from CPU core 10 to control selector 139. Specifically, if the branch is not taken, the address value currently stored in register 123 is selected as a new value of read pointer 131; if the branch is taken, the address value currently stored in register 124 is selected as a new value of read pointer 131. Thus, read pointer 131 can continue to move along the correct track and perform a similar speculative execution for the next branch instruction. At the same time, instruction control unit 12 sends information to CPU core 10. Similarly to the method in the embodiment in FIG. 4, based on whether or not the branch is taken, instruction control unit 12 keeps the execution results of the speculative execution instructions with the same labels in CPU core 10 and clears the execution results or intermediate results of the speculative execution instructions with different labels.

Further, selection control logic is added based on the embodiment in FIG. 8. When the capability of CPU core to execute the instructions cannot be fully used due to correlation between the instructions, instruction control unit 12 can control memory system 11 to provide the instructions of the instruction segment that is predicated as most likely not to be executed for CPU core 10 to execute, taking fully advantage of the capability of CPU core to execute the instructions. The structure of the selection control logic is similar to the structure of the selection logic 132 described in FIG. 4, and the implementation of the selection control logic is similar to the implementation shown in FIG. 6b, which are not repeated herein.

Thus, by combining various current branch prediction methods, if the branch prediction is correct, the technology solution consistent with the disclosed embodiments can reach the same effect generated by current branch prediction methods. Once the branch prediction is incorrect, some instructions in the correct instruction segment are executed completely by the technology solution consistent with the disclosed embodiments. Therefore, the technology solution consistent with the disclosed embodiments can achieve better performance than the current branch prediction methods.

FIG. 9a illustrates another structure schematic diagram of an exemplary multiple issue instruction processing system consistent with the disclosed embodiments. As shown in FIG. 9a, read pointer 131 of the tracker 150 moves in advance and points to a branch instruction after one level of branch. The tracker 150 includes four registers which are configured to store instruction segment addresses. The four registers are configured to store an address of a fall-through instruction segment of a fall-through instruction segment, an address of a target instruction segment of the fall-through instruction segment, an address of a fall-through instruction segment of a target instruction segment, and an address of a target instruction segment of the target instruction segment, respectively. The address of the fall-through instruction segment is obtained by increasing the value of read pointer 131 of the tracker 150. Then, the address of the fall-through instruction segment of the fall-through instruction segment is obtained by increasing the branch instruction address of the fall-through instruction segment. Based on the branch instruction address of the fall-through instruction segment, the address of the target instruction segment of the fall-through instruction segment is read out from the track table. Or based on the branch instruction pointed to by read pointer 131 of the tracker 150, the address of the target instruction segment of the branch instruction is read out from the track table. Then, the address of the fall-through instruction segment of the target instruction segment is obtained by increasing the branch instruction address of the target instruction segment. Based on the branch instruction address of the target instruction segment, the address of the target instruction segment of the target instruction segment is read out from the track table.

In one embodiment, label generator 149 of segment pruner 121 gives different segments to the target instruction segment of every branch instruction and the fall-through instruction segment of every branch instruction, and gives different segment number to every segment. Instruction control unit 12 controls memory system 11 through bus 141 to provide an instruction likely to be executed for CPU core 10 and provides a segment number corresponding to the instruction for CPU core 10 at the same time. Specially, all continuous non-branch instructions before the branch instruction and the branch instruction belong to the same instruction segment. For example, a segment number that is given to instruction segment A is LA; a segment number that is given to instruction segment B is LB; a segment number that is given to instruction segment C is LC; a segment number that is given to instruction segment D is LD; a segment number that is given to instruction segment E is LE; a segment number that is given to instruction segment F is LF; and a segment number that is given to instruction segment G is LG. It should be noted that segment numbers that are given to instruction segments in different time period may be same. For example, a segment number that is given to instruction segment A is LA, while instruction segment A is executed completely, and a segment number of a subsequent instruction segment (e.g. instruction segment H) may be LA. Other similar situations may also use the same method.

The segment pruner 121 includes a pruner 148. The pruner 148 keeps segment numbers corresponding to a number of levels of branch target instruction segments and the fall-through instruction segments from a branch instruction being executed by CPU core 10. Specifically, the segment numbers stored in pruner 148 correspond to the number of levels of branch instructions predicted by tracker 150. After CPU core 10 generates a branch determination corresponding to a branch instruction, a half of segment numbers corresponding to instruction segments likely to be executed are selected from the segment numbers stored in pruner 148, where the half of segment numbers contain a segment number of instruction segment certainly to be executed corresponding to the branch instruction; the other half of segment numbers corresponding to instruction segments certainly not to be executed may be selected.

For example, if a branch determination corresponding to a branch instruction generated by CPU core 10 indicates that a branch is taken, a segment number of target instruction segment corresponding to the branch instruction is a segment number of an instruction segment certainly to be executed, and segment numbers of other levels of instruction segments from the target instruction segment are segment numbers of instruction segments likely to be executed. Accordingly, segment numbers corresponding to a fall-through instruction segment of the branch instruction and other levels of instruction segments after the fall-through instruction segment are segment numbers certainly not to be executed. The segment numbers certainly not to be executed are sent to CPU core 10, such that execution results and intermediate results of the corresponding instruction segments can be cleared.

Thus, when a branch determination corresponding to a branch instruction is generated, a half of instruction segments are cut. At the same time, read pointer 131 of tracker 150 moves on to the next level of branch instruction, and points to new instruction segments with the same number of the previous level. Segment numbers are assigned by segment pruner 121, such that segment numbers stored in pruner 148 are updated.

FIG. 9b illustrates a schematic diagram of an exemplary generating process of four registers' value of a tracker consistent with the disclosed embodiments. As shown in FIG. 9b, each row represents one step in the generating process, and each column corresponds to a register value of the tracker in FIG. 9a. Each column from left to right corresponds to each register of the tracker from left to right in FIG. 9a, respectively. For the instruction segments in FIG. 5b, the address of instruction segment ‘A’ is stored in the first left register shown the first row in FIG. 9b.

At the beginning, based on a branch instruction “a” of instruction segment “A” certainly to be executed, the address of a fall-through instruction segment “B” is obtained by an incrementer and stored in the second left register. At the same time, the address of a target segment “C” of the branch instruction “a” is read out from the track table and stored in the fourth left register shown in the second row in FIG. 9b.

Then, based on a branch instruction “b” of instruction segment “B”, the address of a fall-through instruction segment “D” is obtained by the incrementer and stored in the first left register. At the same time, the address of a target segment “E” of the branch instruction “b” is read out from the track table and stored in the third left register. Further, based on a branch instruction “c” of instruction segment “C”, the address of a fall-through instruction segment “F” is obtained by the incrementer and stored in the second left register. At the same time, the address of a target segment “G” of the branch instruction “c” is read out from the track table and stored in the fourth left register shown in the third row in FIG. 9b.

Thus, four register values in tracker 150 are generated completely. In the process of generating the register values, selector 151 selects one of these register values by the above method, or selects all or part of these register values in order. The selected value(s) may be sent to L1 memory 110 via bus 152 to output instructions of the corresponding instruction segment for CPU core 10 to execute. At the same time, selector 153 selects a segment number corresponding to the address of the instruction segment on bus 152. The selected segment number is sent to CPU core 10 via bus 129 to label the corresponding instruction segment.

When CPU core 10 executes a branch instruction and obtains an execution result indicating whether a branch is taken, CPU core 10 sends the execution result to instruction control unit 12. Based on the execution result sent by CPU core 10, the pruner 148 distinguishes segment numbers of instruction segments certainly not to be executed in pruner 148. The segment numbers of instruction segments certainly not to be executed are sent to CPU core 10 via bus 128. Based on the received segment numbers corresponding to instruction segments certainly not to be executed, CPU core 10 deletes the intermediate results and final results of the instruction segments.

In addition, pruner 148 distinguishes the segment numbers of the instruction segments certainly to be executed in pruner 148 and sends the segment numbers of instruction segments certainly to be executed to CPU core 10 via bus 135. Based on the received segment numbers of instruction segments certainly to be executed, CPU core 10 writes final results of the corresponding instruction segments to physical registers.

It should be noted that register file of the multiple issue processing system generally is in the form of virtual register files including physical registers, or in the form of the combination of reorder buffer and physical registers. The method described in the disclosed embodiments may apply to the multiple issue processing system including these two structures.

Based on the execution result of the branch instruction sent by CPU core 10, information on whether a branch is taken is obtained. For the instruction segments A, B and C, based on information whether a branch is taken in instruction segment A, the information whether instruction segment B is to be executed or instruction segment C is to be executed can be obtained. In the implementing process, all or part of instructions of instruction segment B and instruction segment C are sent to the CPU core 10 to execute. For example, based on information on whether a branch is taken in instruction segment A, instruction segment C is determined not to be executed, and instruction segment B is determined to be executed. At this point, the segment number LC corresponding to instruction segment C is sent to CPU core 10 via bus 128. Based on the received segment number corresponding to instruction segment certainly not to be executed, CPU core 10 deletes the intermediate results and final result of the instruction segment. At the same time, the segment number LB corresponding to instruction segment B is sent to CPU core 10 via bus 135. Based on the received segment number corresponding to the instruction segment certainly to be executed, CPU core 10 writes the final result of the corresponding instruction segment to physical register 4. Thus, CPU core 10 possibly processes a part of instructions in instruction segment C, some intermediate results are generated. Or CPU core 10 possibly processes completely instruction segment C, a final result is generated (the final result has not yet been written to the physical register in CPU core 10). The results generated by instruction segment C need to be deleted in both situations.

Specifically, two segment numbers entered by each pruner module 133 belong to a fall-through instruction segment or the subsequent instruction segment and a target instruction segment or the subsequent instruction segment of the L1 branch instruction being executed, respectively. Based on information on whether a branch is taken sent by CPU core 10, pruner module 133 can select a segment number of one instruction segment certainly not to be executed from these two segment numbers, and selects a segment number of one instruction segment likely to be executed. The segment number of the instruction segment certainly not to be executed is sent to CPU core 10 via bus 128 to clear the execution results and intermediate results corresponding to the instruction segment. The segment number of the instruction segment likely to be executed is sent to the next level of pruner module to wait for the execution result of a next branch instruction.

Similarly, two segment numbers entered by pruner module 134 of the last level belong to a fall-through instruction segment and a target instruction segment of the same branch instruction, respectively. Based on information on whether a branch is taken sent by CPU core 10, pruner module 133 can select a segment number of one instruction segment certainly not to be executed from these two segment numbers, and selects a segment number of one instruction segment certainly to be executed. The segment number of the instruction segment certainly not to be executed is sent to CPU core 10 via bus 128 to clear the execution results and intermediate results corresponding to the instruction segment. The segment number of the instruction segment certainly to be executed is sent to CPU core 10 via bus 135 to write back the execution result corresponding to the instruction segment to the physical register.

It should be noted that the pruner module may not need to generate both the segment number of one instruction segment certainly not to be executed and the segment number of one instruction segment likely to be executed (a segment number of one instruction segment certainly to be executed). For example, the pruner module only generates a segment number of one instruction segment certainly not to be executed and clears the execution results and intermediate results corresponding to the instruction segment in the CPU core. A counter is used in the system. When a number counted by the counter reaches a preset value, the execution results of instruction segment that are not cleared are written back to the physical register. For another example, the pruner module only generates a segment number of one instruction segment certainly to be executed. Based on the segment number of the instruction segment certainly to be executed, the execution results corresponding to the instruction segment are written back to the physical register, and the execution results corresponding to other instruction segments are not written back to the physical register. These two methods can achieve the same effect in the embodiment in FIG. 9A.

Further, instructions likely to be executed outputted to CPU core 10 may belong to multiple threads. FIG. 10 illustrates another structure schematic diagram of an exemplary multiple issue instruction processing system consistent with the disclosed embodiments. As shown in FIG. 10, the structure of tracker 120 is similar to the structure of the tracker in FIG. 9a. The difference is that four register files replace four registers configured to store the addresses of instruction segments in FIG. 9. Every register file includes four registers configured to store the addresses of instruction segments corresponding to four different threads. A branch instruction in tracker 120 belongs to one of four threads. An instruction likely to be executed provided for CPU core 10 belongs to one of four threads.

The label generator of segment pruner 121 labels both segment number 147 of the instruction segment containing the instruction and thread number 146 of the instruction. That is, a segment number with a thread number labels an instruction segment that is sent to CPU core 10 to execute and an instruction segment that needs to be cleared.

FIG. 11 illustrates a structure schematic diagram of an exemplary label generated by a segment pruner consistent with the disclosed embodiments. As shown in FIG. 11, based on the label given by segment pruner 121, the thread and instruction segment containing the instruction can be directly obtained, achieving a tracker structure that supports four threads simultaneously. At this point, the corresponding registers of different register files in tracker 120 correspond to the same thread. Thus, when the processor switches threads, the track address in the register corresponding to the thread can be directly used to control the memory system to provide the instructions for the CPU core to achieve thread switch without waiting.

In the multiple issue instruction processing system provided in the present disclosure, an instruction control unit configured to, based on location of a branch instruction stored in a track table, control the memory system to provide the instructions to be executed likely for the CPU to take full advantage of capability of CPU core to execute the instructions, improving performance of the multiple issue instruction processing system to execute the instructions. Other advantages and applications are obvious to those skilled in the art.

The disclosed systems and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure. Industrial Applicability

The disclosed systems and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

### SEQUENCE LISTING FREE TEXT

Sequence List Text

1. A multiple issue instruction processing system, comprising:
a central processing unit (CPU) configured to execute one or more instructions of executable instructions at the same time;
a memory system configured to store the instructions; and
an instruction control unit configured to, based on location of a branch instruction stored in a track table, control the memory system to output the instructions likely to be executed to the CPU.

2. The system according to claim 1, wherein:
the instruction control unit further includes a tracker, and the tracker is configured to:
based on the location of the branch instruction stored in the track table, move in advance from a first branch instruction of an instruction being executed by the CPU and points to a branch instruction after a number of levels of branches;
based on the branch instruction passed in the process of the tracker moving, select the instructions in the corresponding instruction segment; and
control the memory system to output the selected instructions to the CPU.

3. The system according to claim 2, wherein:
the instruction control unit also includes a segment pruner configured to give different segments to a target instruction segment of every branch instruction and a fall-through instruction segment of every branch instruction, and to give different segment number to every segment; and
the instruction control unit is further configured to control the memory system to output an instruction likely to be executed to the CPU and output simultaneously a segment number corresponding to the instruction likely to be executed to the CPU.

4. The system according to claim 2, wherein:
the branch instruction and all continuous non-branch instructions before the branch instruction belong to a same instruction segment.

5. The system according to claim 3, wherein:
the segment pruner includes a pruner configured to keep segment numbers corresponding to a number of levels of branch target instruction segments and fall-through instruction segments from a branch instruction being executed by the CPU.

6. The system according to claim 5, wherein:
when the CPU executes a branch instruction and obtains an execution result indicating whether a branch is taken, the CPU sends the execution result to the instruction control unit.

7. The system according to claim 6, wherein:
based on the execution result sent from the CPU to the instruction control unit, the pruner distinguishes the segment numbers of the instruction segments certainly to be executed in the pruner and sends the segment numbers of instruction segments certainly to be executed to the CPU.

8. The system according to claim 7, wherein:
based on the received segment numbers of instruction segments certainly to be executed, the CPU writes final results generated by the corresponding instruction segments to physical registers.

9. The system according to claim 8, wherein:
based on the execution results sent from the CPU to the instruction control unit, the pruner distinguishes segment numbers of the instruction segments certainly not to be executed in the pruner and sends the segment numbers of the instruction segments certainly not to be executed to CPU.

10. The system according to claim 9, wherein:
based on the received segment numbers corresponding to the instruction segments certainly not to be executed, the CPU deletes intermediate results and final results of the instruction segments.

11. The system according to claim 10, wherein selecting instructions in the instruction segments by instruction control unit includes:
selecting evenly the instructions of the fall-through instruction segment and the target instruction segment of every level branch.

12. The system according to claim 10, wherein selecting instructions in the instruction segments by instruction control unit further includes:
based on a certain algorithm, selecting unevenly the instructions of the fall-through instruction segment and the target instruction segment of every level branch.

13. The system according to claim 10, wherein:
a branch prediction bit of the branch instruction is stored in the track table, wherein the branch prediction bit provides a prediction probability that the branch of the branch instruction is taken.

14. The system according to claim 13, wherein:
when the probability that the branch instruction takes a branch is higher than a probability that the branch is not taken, the instruction control unit controls the memory system to output the instructions of the target instruction segment and the fall-through instruction segment of the branch instruction to the CPU, wherein the instructions of the target instruction segment of the branch instruction are more than the instructions of the fall-through instruction segment of the branch instruction in the outputted instructions; and
when the probability that the branch instruction takes a branch is lower than the probability that the branch is not taken, the instruction control unit controls the memory system to provide the instructions of the target instruction segment and the fall-through instruction segment of the branch instruction for the CPU, wherein the instructions of the target instruction segment of the branch instruction are less than the instructions of the fall-through instruction segment of the branch instruction in the outputted instructions.

15. The system according to claim 14, wherein:
the prediction bit is any one of a single bit and a plurality of bits, wherein an initial value of the prediction bit is set to any one of a fixed value and a value that changes based on a branch jump direction of the branch instruction.

16. The system according to claim 14, wherein:
based on information on whether the branch instruction executed by the CPU takes a branch, a prediction value corresponding to the branch instruction in the track table is modified.

17. The system according to claim 9, further including:
a queue unit configured to store instructions likely to be executed outputted by the memory system; and
based on segment numbers corresponding to the received instruction segments that needs to be deleted, the queue unit deletes the instructions of the corresponding instruction segments.

18. The system according to claim 7, wherein:
the instructions likely to be executed that are outputted to CPU belong to multiple threads.

19. The system according to claim 18, wherein:
the segment pruner labels a thread number of the thread that the instruction belongs to and the segment number of the instruction segment containing the instruction.

20. A multiple issue instruction processing method, comprising:
storing, by a memory system, instructions;
based on location of a branch instruction stored in a track table, controlling, by an instruction control unit, the memory system to output the instructions likely to be executed to a CPU; and
receiving, by the CPU, the instructions likely to be executed outputted by the memory system and executing one or more instructions of executable instructions at the same time.

21. The method according to claim 20, before the instruction control unit controls the memory system to output the instructions likely to be executed to the CPU, further including:
classifying, by the instruction control unit, the branch instruction and all continuous non-branch instructions before the branch instruction as a same instruction segment.

22. The method according to claim 21, wherein classifying the branch instruction and all continuous non-branch instructions before the branch instruction as a same instruction segment further includes:
giving, by the instruction control unit, different segments to a target instruction segment and a fall-through instruction segment of every branch instruction.

23. The method according to claim 22, after classifying the branch instruction and all continuous non-branch instructions before the branch instruction as a same instruction segment, further including:
giving, by the instruction control unit, different segment number to every segment.

24. The method according to claim 23, wherein:
the instruction control unit controls the memory system to output an instruction likely to be executed to the CPU and outputs simultaneously a segment number corresponding to the instruction to the CPU.

25. The method according to claim 24, wherein:
when the CPU executes a branch instruction and obtains execution result indicating whether a branch is taken, the CPU sends the execution result to instruction control unit.

26. The method according to claim 25, wherein:
based on the execution results sent from the CPU to the instruction control unit, the instruction control unit distinguishes the segment numbers of instruction segments certainly to be executed and sends the segment numbers of the instruction segments certainly to be executed to the CPU.

27. The method according to claim 26, wherein:
based on the received segment numbers of the instruction segments certainly to be executed, the CPU writes final results generated by the corresponding instruction segments to physical registers.

28. The method according to claim 25, wherein:
based on the execution results sent from the CPU to the instruction control unit, the instruction control unit distinguishes the segment numbers of instruction segments certainly not to be executed in the pruner and sends the segment numbers of the instruction segments certainly not to be executed to the CPU.

29. The method according to claim 28, wherein:
based on the received segment numbers of instruction segments certainly not to be executed, the CPU deletes intermediate results and final results of the instruction segments.
